(19) United States
(12) Patent Application Publication
(10) Pub. No.: US 2023/0274300 A1
(43) Pub. Date: Aug. 31, 2023

(54) MOBILITY SERVICE APPARATUS AND METHOD USING FLEXIBLE RATE

(71) Applicants: HYUNDAI MOTOR COMPANY, Seoul (KR); Kia Corporation, Seoul (KR)

(72) Inventors: Yoonsun KYE, Seoul (KR); Kyong Enn MIN, Seoul (KR); Hyungu ROH, Seongnam-si (KR); Youjin JANG, Seoul (KR); Hyunjin LEE, Seoul (KR); Younghyun JU, Yongin-si (KR); Eonjoung CHOI, Seoul (KR)

(73) Assignees: HYUNDAI MOTOR COMPANY, Seoul (KR); Kia Corporation, Seoul (KR)

(21) Appl. No.: 17/965,242

(22) Filed: Oct. 13, 2022

(30) Foreign Application Priority Data
Feb. 25, 2022 (KR) 10-2022-0025312

(51) Int. Cl. G06Q 30/02; G08G 1/00

(52) U.S. Cl. CPC G06Q 30/0206; G08G 1/202; G06Q 50/30

(57) ABSTRACT

A mobility service apparatus receives a call for vehicle assignment from a user device, determines a vehicle to be assigned to the user device, determines a surcharge rate to be applied to a fare based on an estimated waiting time of the call from the user device when a predetermined condition is satisfied, and transmits an assignment acceptance request, including information related to the surcharge rate, to the user device.

### CROSS-REFERENCE TO RELATED APPLICATION

This application claims priority to and the benefit of Korean Patent Application No. 10-2022-0025312 filed in the Korean Intellectual Property Office on Feb. 25, 2022, the entire contents of which are incorporated herein by reference.

### TECHNICAL FIELD

The disclosure relates to a mobility service apparatus and method using a flexible fare.

### BACKGROUND

Recently, various types of mobility services have been provided. In the mobility service, when a user calls a vehicle via a terminal (or a device), a server assigns a vehicle to the user and the user can get on the assigned vehicle. In this case, there is a mobility service in which a fare is determined based on the distance from a departure point of the user to a destination or the time required for reaching the destination from the departure point. Alternatively, among the mobility services providing services in a certain area, there is a service whose fee is paid with a pass issued for a certain period or a fixed fee per usage, after granting membership rights by a monthly subscription fee.

In such a mobility service, many users call vehicles during peak time, which causes a longer waiting time. As a result, the quality of the mobility service may be deteriorated. Therefore, there is a need for a method that can reduce the waiting demand of mobility service users.

The above information disclosed in this Background section is only for enhancement of understanding of the background of the disclosure, and therefore it may contain information that does not form the prior art that is already known in this country to a person of ordinary skill in the art.

### SUMMARY

Some embodiments may provide a mobility service apparatus and method that can reduce waiting demand of users.

According to some embodiments, a mobility service method executed by a computing device may be provided. The mobility service method may include receiving a call for vehicle assignment from a user device (or a user terminal), determining a vehicle to be assigned to the user device, determining a surcharge rate to be applied to a fare based on an estimated waiting time of the call from the user device in response to a predetermined condition being satisfied, and transmitting an assignment acceptance request, including information related to the surcharge rate, to the user device.

In some embodiments, the mobility service method may further include determining a fare obtained from multiplying a base fare by the surcharge rate as a flexible base fare. The information related to the surcharge rate may include the flexible base fare.

In some embodiments, the predetermined condition may include a condition that the estimated waiting time exceeds a predetermined time.

In some embodiments, the predetermined condition may include at least one of a condition that a number of calls occurred during a predetermined period before receiving the call is equal to or greater than a threshold, or a condition that there is a call whose estimated waiting time is equal to greater than a threshold time among the calls occurred during the predetermined period.

In some embodiments, determining the surcharge rate may include determining the surcharge rate based on a value that is obtained from dividing the estimated waiting time of the call from the user device by an average estimated waiting time during a predetermined period before receiving the call.

In some embodiments, determining the premium rate may include calculating the premium rate based on a call cancellation rate corresponding to an expected waiting time of the user device.

In some embodiments, determining the surcharge rate may include determining the surcharge rate based on the estimated waiting time of the call from the user device, determining an additional surcharge rate in response to a condition for additional surcharge being satisfied, and applying the additional surcharge rate to the surcharge rate.

In some embodiments, the condition for additional surcharge may include a condition that the estimated waiting time falls within a time section of estimated waiting time in which there is no change in call cancellation rate after applying the surcharge rate.

In some embodiments, the condition for additional surcharge may include a condition that a number of calls during a predetermined time exceeds a threshold.

In some embodiments, the condition for additional surcharge may include a condition that the estimated waiting time exceeds a predetermined time and number of calls exceeds a threshold.

In some embodiments, the condition for additional surcharge may include a condition that the estimated waiting time exceeds a threshold time.

According to some embodiments, a mobility service apparatus including a communication interface, a memory configured to store one or more instructions, and a processor configured to execute the one or more instructions may be provided. By executing the instructions, the processor may receive a call for vehicle assignment from a user device via the communication interface, determine a vehicle to be assigned to the user device, determine a surcharged base fare based on an estimated waiting time of the call from the user device, transmit an assignment acceptance request, including information related to a surcharged base fare, to the user device via the communication interface.

According to some embodiments, a computer program executed by a computing device and stored on a non-transitory storage medium may be provided. The computer program may cause the computing device to execute receiving a call for vehicle assignment from a user device, determining a vehicle to be assigned to the user device, determining a surcharge rate to be applied to a fare based on estimated waiting time of the call from the user device in response to a predetermined condition being satisfied, and transmitting an assignment acceptance request, including information related to the surcharge rate, to the user device.

### BRIEF DESCRIPTION OF THE DRAWINGS

FIG. 1 is a diagram illustrating a mobility service providing system according to an embodiment.

FIG. 2 is a diagram illustrating a mobility operation server according to an embodiment.

FIG. 3 is a flowchart illustrating a mobility service method according to an embodiment.

FIG. 4 is a flowchart illustrating a mobility service method according to another embodiment.

FIG. 5 is a flowchart illustrating a mobility service method according to another embodiment.

FIG. 6 is a block diagram illustrating a mobility service apparatus according to an embodiment.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

As used herein, the singular forms “a” and “an” are intended to include the plural forms as well, unless the context clearly indicates otherwise.

The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

An expression such as “first” and “second” indicate various constituent elements regardless of order and/or importance, is used for distinguishing a constituent element from another constituent element, and does not limit corresponding constituent elements. For example, a first constituent element may be referred to as a second constituent element without deviating from the scope described in the present specification, and similarly, a second constituent element may be referred to as a first constituent element.

An expression such as “have,” “comprise,” or “include” indicates existence of a corresponding feature (e.g., constituent elements such as a numerical value, function, operation, or component) and does not exclude the presence of another feature.

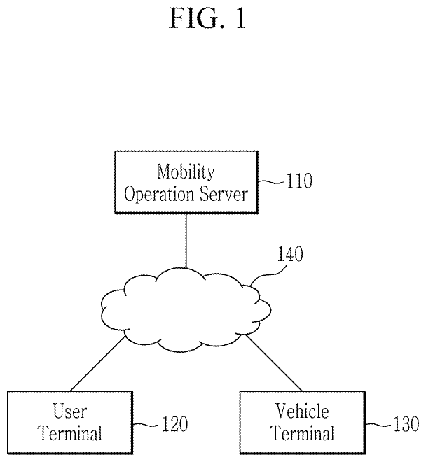

FIG. 1 is a diagram illustrating a mobility service providing system according to an embodiment.

Referring to FIG. 1, a mobility service providing system includes a mobility operation server 110, a user device (or a user terminal) 120, and a vehicle terminal 130.

The mobility operation server 110 can communicate with the user device 120 and the vehicle terminal 130, which are connected thereto via a network 140. Further, the mobility operation server 110 can assign a vehicle in response to a request from the user device 120 and provide assignment information to the vehicle terminal 130 of the assigned vehicle and the user device 120. The user device (or the user terminal) 120 is a terminal possessed by a user who intends to use a mobility service. The user may transmit a call for vehicle assignment to the mobility operation server 110 through an application (referred to as “app”) installed on the user device 120. The vehicle terminal 130 is a terminal provided in a vehicle.

In some embodiments, the mobility operation server 110, the user device 120, or the vehicle terminal 130 may be implemented with a computing device. In some embodiments, the user device 120 or the vehicle terminal 130 may be implemented with a terminal, such as a mobile phone, a smartphone, a laptop computer, a tablet computer, a navigation device, an in-vehicle infotainment device, or a wearable device among computing devices.

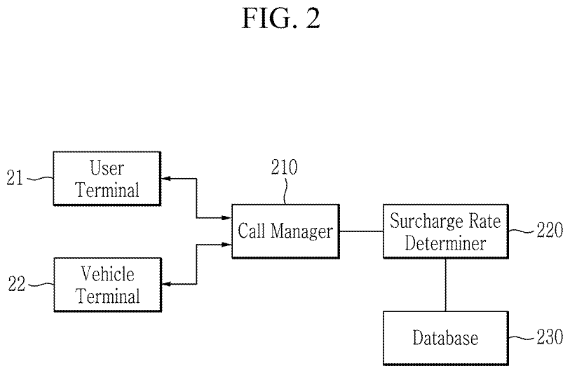

FIG. 2 is a diagram illustrating a mobility operation server according to an embodiment.

Referring to FIG. 2, a mobility operation server (or mobility service apparatus) includes a call manager 210, a surcharge rate determiner 220, and a database 230.

The call manager 210 receives a call for vehicle assignment from a user device (or a user terminal) 21, and determines a vehicle to be assigned among a plurality of vehicles and an estimated waiting time. The call manager 210 can transmit an assignment acceptance request including assignment information to the user device 21. Upon receiving an assignment acceptance response from the user device 21, the call manager 20 can complete assignment by transmitting information on the user device to a vehicle terminal 22 of the assigned vehicle. The call manager 210 can cancel the call when the call manager 210 receives an assignment cancellation response from the user device 210 or does not receive the assignment acceptance response within a predetermined time. In some embodiments, the assignment information may include information related to estimated waiting time and a flexible fare. In some embodiments, the assignment information may further include information of the assigned vehicle.

The surcharge rate determiner 220 may set a surcharge rate depending on the estimated waiting time, and use a fare obtained by multiplying a base fare and the surcharge rate as the flexible base fare. The surcharge rate determiner 220 may set an amount obtained by multiplying the base fare and the surcharge rate as the flexible base fare (surcharged base fare). In some embodiment, the surcharge rate determiner 220 may set the surcharge rate to increase as the waiting time increases. In some embodiments, the surcharge rate determiner 220 may determine a case where the waiting time is less than or equal to a lower limit time as a normal operation. At this time, the surcharge rate determiner 220 may not apply the surcharge rate. In some embodiments, the surcharge rate determiner 220 may apply a same surcharge rate (maximum surcharge rate) to cases where the waiting time is greater than or equal to an upper limit time.

The database 230 stores the surcharge rate per waiting time. In some embodiments, the database 230 may store a call cancellation rate per waiting time. The cancellation rate per waiting time may be generated based on existing statistical data. The existing statistical data may be statistical data when a fixed fare is applied regardless of a length of the waiting time. In some embodiments, call cancellation used for calculating the call cancellation rate may include a case where an app is executed and a fare is inquired for calling a service but the app is terminated or the call is finally not made.

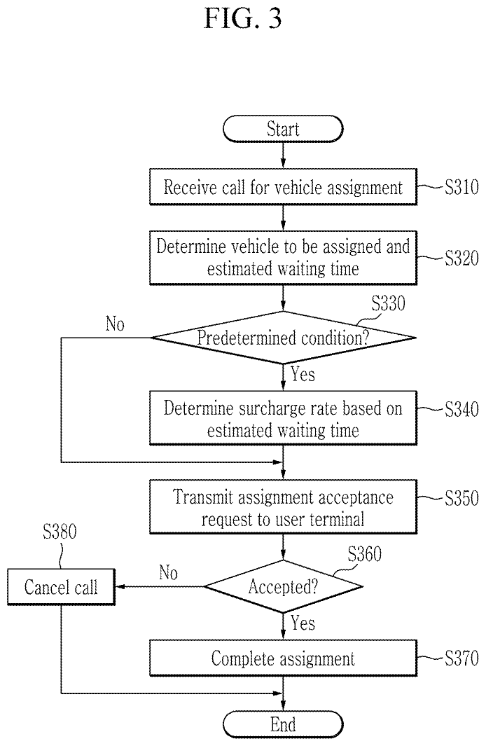

FIG. 3 is a flowchart illustrating a mobility service method according to an embodiment.

Referring to FIG. 3, a mobility operation server receives a call for vehicle assignment from a user device at S310. In some embodiments, the call may include current location information of the user device and information of the user device. The information of the user device may include identification information (e.g., phone number) of the user device. In some embodiments, the call may further include destination information of the user. In some embodiments, the user can request a call for vehicle by running an app for a mobility service on the user device and inputting destination information to the app.

The mobility operation server determines a vehicle to be assigned to the user among a plurality of vehicles in operation and estimated waiting time at S320. In some embodiments, the mobility operation server may determine the vehicle to be assigned based on the current location information of the user device. In some embodiments, the mobility operation server may determine, as the vehicle to be assigned, a vehicle that can reach the current location of the user device in a shortest time with no passenger on board. The estimated waiting time may be an estimated time that it takes for an assigned vehicle to reach the current location of the user device when a time point of the call is set as a start time point.

When a predetermined condition is satisfied at S330, the mobility operation server determines a surcharge rate based on the estimated waiting time of the call from the user device at S340. The surcharge rate may also be interpreted as a surcharge amount. In some embodiments, at S340, the mobility operation server may determine the surcharge rate based on a value obtained through dividing the estimated waiting time of the call from the user device by an average of the estimated waiting time of calls occurred during an immediately preceding predetermined period. In some embodiments, the predetermined condition may include a condition that the estimated waiting time exceeds a predetermined time (lower limit time). That is, the mobility operation server may determine a case where the estimated waiting time is less than or equal to the lower limit time (e.g., 10 minutes) as a normal operation, and may not apply the surcharge rate. In some embodiments, the mobility operation server may apply the same surcharge rate (maximum premium rate) to cases where the estimated waiting time is greater than or equal to an upper limit time. For example, the mobility operation server may set the premium rate depending on the estimated wait time as shown in Table 1. In an example of Table 1, a surcharge rate of 1.5 may be equally applied when the lower limit time is 10 minutes, the upper limit time is 15 minutes, and the estimated wait time is 15 minutes or more.

TABLE 1

| Estimated waiting time (minutes) | Surcharge rate | Base rate |
|---|---|---|
| 10 | 1.0 | 2,000 |
| 11 | 1.1 | 2,200 |
| 12 | 1.2 | 2,400 |
| 13 | 1.3 | 2,600 |
| 14 | 1.4 | 2,800 |
| 15 | 1.5 | 3,000 |

In some embodiments, the predetermined condition of S330 may include a condition determined by calls made in an immediately preceding predetermined period of the time point of a call. In one embodiment, the predetermined condition may include a condition that the number of calls occurred during an immediately preceding predetermined period is equal to or greater than a threshold. In another embodiment, the predetermined condition may include a condition that there are calls whose estimated waiting time is equal to or greater than threshold time among calls occurred during an immediately preceding predetermined period. In another embodiment, the predetermined condition may include a condition that the number of calls occurred during an immediately preceding predetermined period is equal to or greater than a threshold, and a condition that there are calls whose estimated waiting time is equal to or greater than a threshold time among calls occurred during an immediately preceding predetermined period. For example, the predetermined condition may be a condition that at least 5 calls are made in the last 10 minutes from when the call is made and there is a call with an estimated waiting time of 20 minutes or more. As such, the mobility operation server may determine to apply a flexible fare when a large number of calls are made and there is a call with an increased estimated waiting time due to a large number of calls.

The mobility operation server transmits an assignment acceptance request including assignment information to the user device at S350. The assignment acceptance request includes an estimated waiting time. When the surcharge rate is applied, the assignment acceptance request further includes information related to the surcharge rate. In some embodiments, the information related to the surcharge rate may include a flexible fare determined by applying the surcharge rate or the surcharge rate. In some embodiments, the assignment acceptance request may further include information on the assigned vehicle.

In some embodiments, a flat fare may be used for the mobility service. In this case, the mobility operation server may calculate the surcharged flexible base fare by multiplying the flat fare (i.e., base fare) and the surcharge rate. The information related to the surcharge rate may include the flexible base fare. In some embodiments, a flat fare may not be used for the mobility service. For example, the fare may be determined based on a distance from the current location of the user device to the destination or the time required for reaching the destination from the current location. In this case, the information related to the surcharge rate may include the surcharge rate. Accordingly, the final fare may be determined by multiplying the fare determined based on the distance or time and the surcharge rate, after reaching the destination.

If the user device accepts the assignment in response to the assignment acceptance request at S360, the mobility operation server completes the vehicle assignment by transmitting the information on the user device to the vehicle terminal of the assigned vehicle at S370. In some embodiments, the information on the user device may include current location information of the user device and identification information (e.g., phone number) of the user device. In some embodiments, the mobility operation server may transmit information on the assigned vehicle to the user device.

If the user device does not accept the assignment in response to the assignment acceptance request at S360, the mobility operation server does not assign a vehicle to the user device, and cancels the call at S380.

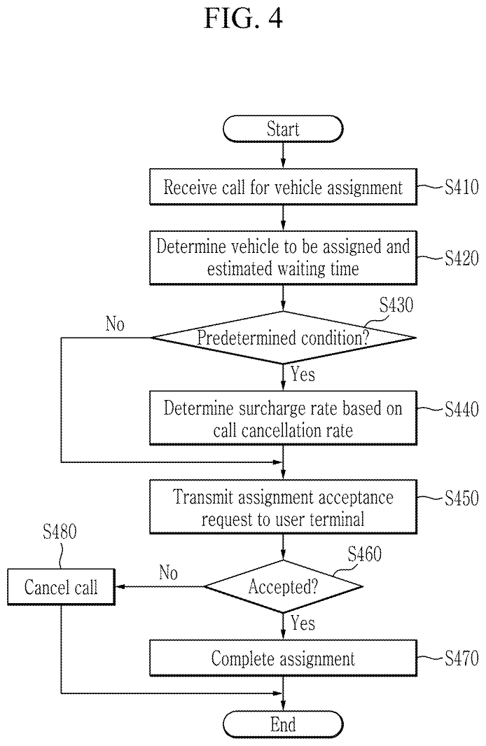

FIG. 4 is a flowchart illustrating a mobility service method according to another embodiment.

Since operations of S410, S420, S430, S450, S460, S470 and S480 shown in FIG. 4 are the same as operations of S310, S320, S330, S350, S360, S370 and S380 described with reference to FIG. 3, a description thereof is omitted.

The mobility operation server determines a surcharge rate based on a call cancellation rate corresponding to estimated waiting time of a call from a user device at S440. In some embodiments, the mobility operation server may determine the surcharge rate based on a call cancellation rate per waiting time analyzed based on existing statistical data. In some embodiments, the mobility operation server may calculate a value obtained by multiplying the call cancellation rate and a constant as a surcharge rate. In one embodiment, the mobility operation server may apply the same surcharge rate to time sections of waiting time having the same call cancellation rate. That is, when a first estimated waiting time and a second estimated waiting time have the same call cancellation rate, the same surcharge rate may be applied thereto. In another embodiment, the mobility operation server may raise the surcharge rate as the estimated waiting time increases in a time section of the estimated waiting time having the same cancellation rate. That is, different surcharge rates may be applied to the first estimated waiting time and the second estimated waiting time that have the same call cancellation rate. In this case, if the second estimated waiting time is longer than the first estimated waiting time, a higher surcharge rate may be applied to the second estimated waiting time than the first estimated waiting time.

According to the above-described embodiment, when the estimated waiting time gets longer, call demand for the mobility service can be reduced by raising the fare through applying the surcharge rate. As a result, the estimated waiting time can be reduced.

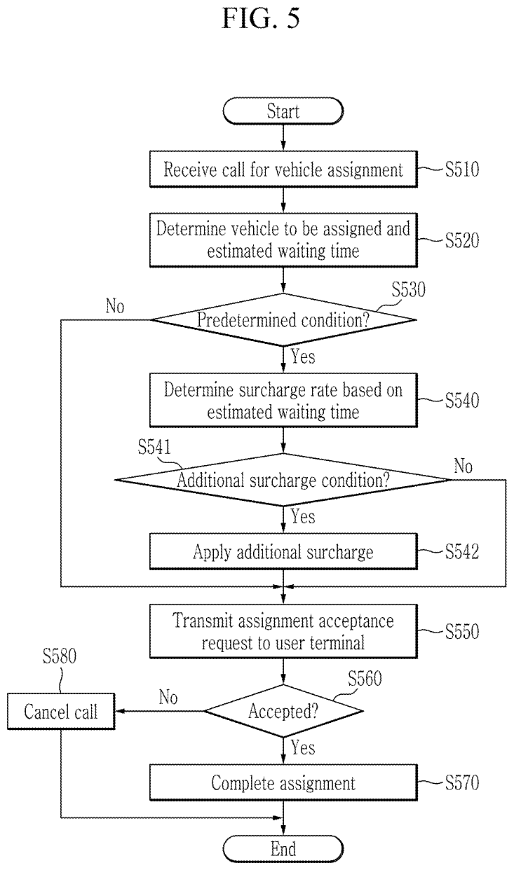

FIG. 5 is a flowchart illustrating mobility service method according to another embodiment.

Since operations of S510, S520, S530, S550, S560, S570 and S580 shown in FIG. 5 are the same as the operations of S310, S320, S330, S350, S360, S370 and S580 described with reference to FIG. 3, a description thereof is omitted.

The mobility operation server determines a surcharge rate based on estimated waiting time of a call from a user device or a call cancellation rate corresponding to the estimated waiting time at S540. In addition, when a condition for an additional surcharge is satisfied at S541, the mobility operation server determines an additional surcharge rate (or additionally surcharged fare), and then determines a value obtained by applying the additional surcharge rate to the surcharge rate as a final surcharge rate at S542. In some embodiments, the mobility operation server may determine a fare obtained by applying an additionally surcharged fare to a flexible base fare, as a final flexible base fare. If the condition for additional surcharge is not satisfied, the mobility operation server does not apply the additional surcharge rate. In this way, raising the surcharge rate through the additional surcharge rate leads to increasing a call cancellation rate. As a result, waiting demand can be reduced.

In some embodiments, the condition for additional surcharge may include a condition that there is a time section of estimated waiting time having no change in the call cancellation rate, upon analyzing the call cancellation rate depending on the estimated waiting time after applying the flexible fare to which the surcharge rate is applied. For the time section of the estimated waiting time having no change in a call cancellation rate, the mobility operation server may calculate the final surcharge rate by applying the additional surcharge rate to the surcharge rate. For example, the additional surcharge rate may be set so that the final surcharge rate becomes twice the existing surcharge rate.

In some embodiments, the condition for additional surcharge may be a condition that the number of calls during a certain period exceeds a threshold. When the number of calls exceeds the threshold during a certain period, the waiting time may increase rapidly. Here, the mobility operation server may calculate the final surcharge rate by applying the additional surcharge rate to the existing surcharge rate.

In some embodiments, the condition for additional surcharge may be a condition that the number of calls exceeds a threshold when the estimated waiting time exceeds a predetermined time (e.g., 10 minutes). When the estimated waiting time exceeds a certain level, an increase in calls may lead to a rapid increase in the waiting time. Thus, the mobility operation server may calculate the final surcharge rate by applying the additional surcharge rate to the existing surcharge rate.

In some embodiments, the condition for additional surcharge may include a condition that estimated waiting time exceeds a threshold time. When the estimated waiting time exceeds the threshold time (e.g., 20 minutes), the mobility operation server may calculate the final surcharge rate by applying the additional surcharge rate to the existing surcharge rate.

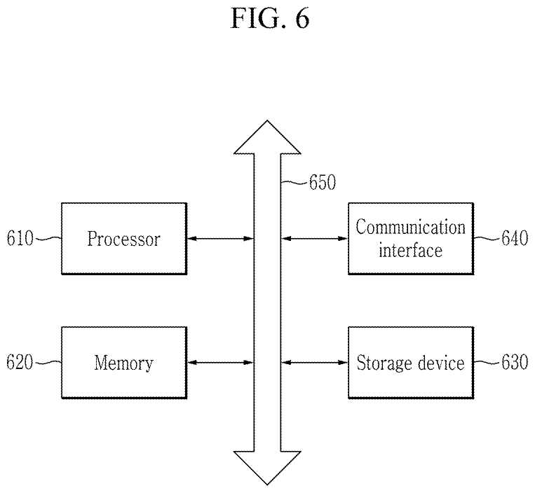

Hereinafter, an exemplary computing device capable of implementing a mobility service apparatus or a mobility service method according to various embodiments is described with reference to FIG. 6.

FIG. 6 is a block diagram illustrating a mobility service apparatus according to an embodiment.

Referring to FIG. 6, a computing device, or a mobility service apparatus includes a processor 610, a memory 620, a storage device 630, a communication interface 640, and a bus 650. The computing device may further include other general components.

The processor 610 controls overall operation of each component of the computing device. The processor 610 may be implemented with at least one of various processing unit such as a central processing unit (CPU), a microprocessor unit (MPU), a micro controller unit (MCU), and a graphic processing unit (GPU), and may be implemented with a parallel processing unit. Further, the processor 610 may perform an operation on a program for executing the above-described mobility service method.

The memory 620 stores various data, instructions and/or information. The memory 620 may load a computer program from the storage device 630 to execute the mobility service method. The storage device 630 may non-temporarily store a program. The storage device 630 may be implemented with a non-volatile memory. The storage device 630 may store the above-described database (e.g., 230 of FIG. 2).

The communication interface 640 supports wired/wireless Internet communication of the computing device. In addition, the communication interface 640 may support various communication methods other than Internet communication. The computing device may communicate with a user device and a vehicle terminal via the communication interface 640.

The bus 650 provides a communication function between components of the computing device. The bus 650 may be implemented with various types of buses, such as an address bus, a data bus, and a control bus.

The computer program may include instructions that cause the processor 610 execute a mobility service method when loaded onto the memory 620. That is, the processor 610 may perform an operation for the mobility service method by executing instructions.

In some embodiments, a mobility service method may be implemented as a computer-readable computer program on a computer-readable medium. In one embodiment, a computer-readable medium may be a removable recording medium or a fixed recording medium. In another embodiment, a computer program recorded on a computer-readable medium may be transmitted to another computing device via a network such as Internet, installed in another computing device, and then may be executed.

In some embodiments, to implement the mobility service method, the computer program may include instructions to execute receiving a call for vehicle assignment from a user device, determining a vehicle to be assigned to the user device, determining a surcharge rate to be applied to a fare based on estimated waiting time of the call from the user device when a predetermined condition is satisfied, and transmitting an assignment acceptance request including information related to the surcharge rate to the user device.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A mobility service method executed by a computing device, the method comprising:
receiving a call for vehicle assignment from a user device;
determining a vehicle to be assigned to the user device;
determining a surcharge rate to be applied to a fare based on an estimated waiting time of the call from the user device in response to a predetermined condition being satisfied; and
transmitting an assignment acceptance request, including information related to the surcharge rate, to the user device.

2. The method of claim 1, further comprising determining a fare obtained from multiplying a base fare by the surcharge rate as a flexible base fare,
wherein the information related to the surcharge rate includes the flexible base fare.

3. The method of claim 1, wherein the predetermined condition comprises a condition that the estimated waiting time exceeds a predetermined time.

4. The method of claim 1, wherein the predetermined condition comprises at least one of a condition that a number of calls occurred during a predetermined period before receiving the call is equal to or greater than a threshold, or a condition that there is a call whose estimated waiting time is equal to greater than a threshold time among the calls occurred during the predetermined period.

5. The method of claim 1, wherein determining the surcharge rate comprises determining the surcharge rate based on a value that is obtained from dividing the estimated waiting time of the call from the user device by an average estimated waiting time during a predetermined period before receiving the call.

6. The method of claim 1, wherein determining the surcharge rate comprises calculating the surcharge rate based on a call cancellation rate corresponding to the estimated waiting time of the user device.

7. The method of claim 1, wherein determining the surcharge rate comprises:
determining the surcharge rate based on the estimated waiting time of the call from the user device;
determining an additional surcharge rate in response to a condition for additional surcharge being satisfied; and
applying the additional surcharge rate to the surcharge rate.

8. The method of claim 7, wherein the condition for additional surcharge comprises a condition that the estimated waiting time falls within a time section of estimated waiting time in which there is no change in call cancellation rate after applying the surcharge rate.

9. The method of claim 7, wherein the condition for additional surcharge comprises a condition that a number of calls during a predetermined time exceeds a threshold.

10. The method of claim 7, wherein the condition for additional surcharge comprises a condition that the estimated waiting time exceeds a predetermined time and a number of calls exceeds a threshold.

11. The method of claim 7, wherein the condition for additional surcharge comprises a condition that the estimated waiting time exceeds a threshold time.

12. A mobility service apparatus comprising:
a communication interface;
a memory configured to store one or more instructions; and
a processor configured to, by executing the one or more instructions:
receive a call for vehicle assignment from a user device via the communication interface;
determine a vehicle to be assigned to the user device;
determine a surcharged base fare based on an estimated waiting time of the call from the user device; and
transmit an assignment acceptance request, including information related to the surcharged base fare, to the user device via the communication interface.

13. The mobility service apparatus of claim 12, wherein the processor is configured to:
determine a surcharge rate based on a value that is obtained from dividing the estimated waiting time of the call from the user device by an average estimated waiting time during a predetermined period before receiving the call; and
determine the surcharged base fare by applying the surcharge rate to a base fare.

14. The mobility service apparatus of claim 12, wherein the processor is configured to:
calculate the surcharge rate based on a call cancellation rate corresponding to the estimated waiting time of the call from the user device; and
determine the surcharged base fare by applying the surcharge rate to a base fare.

15. The mobility service apparatus of claim 12, wherein the processor is configured to:
determine an additional surcharge rate in response to a condition for additional surcharge being satisfied; and
apply the additional surcharge rate to the surcharged base fare.

16. A non-transitory storage medium storing a computer program, when executed by a computing device, causing the computing device to perform:
receiving a call for vehicle assignment from a user device;
determining a vehicle to be assigned to the user device;
determining a surcharge rate to be applied to a fare based on an estimated waiting time of the call from the user device in response to a predetermined condition being satisfied; and
transmitting an assignment acceptance request, including information related to the surcharge rate, to the user device.
